(19) United States
(12) Patent Application Publication
(10) Pub. No.: US 2009/0237560 A1
(43) Pub. Date: Sep. 24, 2009

(54) NETWORKED IP VIDEO WALL

(75) Inventors: Fabio Marco Ganzaroli, Milan (IT); Sofin Raskin, Los Altos, CA (US); Janice Litvinoff, Santa Clara, CA (US)

Correspondence Address: Trellis Intellectual Property Law Group, PC, 1900 EMBARCADERO ROAD, SUITE 109, PALO ALTO, CA, 94303, US

(73) Assignee: CISCO TECHNOLOGY, INC., San Jose, CA (US)

(21) Appl. No.: 12/050,536

(22) Filed: Mar. 18, 2008

(51) Int. Cl. H04N 5/04

(52) U.S. Cl. 348/511; 348/E05.009

(57) ABSTRACT

In one embodiment, a method can include: receiving a synchronization signal in a digital media receiver coupled to a network and a video wall; receiving media content in the digital media receiver; receiving a configuration signal via the network in the digital media receiver; and displaying a designated portion of the media content on the video wall in response to the configuration signal and the synchronization signal.

### TECHNICAL FIELD

The present disclosure relates generally to video displays, and more specifically to flexible video wall displays.

### BACKGROUND

Typical video walls are standalone devices that include a common dimension display matrix, a video matrix appliance with one or more video inputs and as many video outputs as the number of display portions on the video matrix, and in some cases a management station for controlling and managing the video matrix. Such approaches also typically involve little or no Internet protocol (IP) network access.

### BRIEF DESCRIPTION OF THE DRAWINGS

FIG. 1 illustrates an example video wall system with localized video matrix control.

FIG. 2 illustrates an example video wall system with video matrix control in an IP network.

FIG. 3 illustrates an example video wall control system.

FIG. 4 illustrates an example digital media receiver structure.

FIG. 5 illustrates a flow diagram of an example method of controlling a video wall.

### DESCRIPTION OF EXAMPLE EMBODIMENTS

### Overview

In one embodiment, a method can include: receiving a synchronization signal in a digital media receiver coupled to a network and a video wall; receiving media content in the digital media receiver; receiving a configuration signal via the network in the digital media receiver; and displaying a designated portion of the media content on the video wall in response to the configuration signal and the synchronization signal.

### Example Embodiments

In order to overcome a fixed size video wall that may be limited by video matrix output density, constrained video wall shape (e.g., square (N×N displays), rectangular (N×M displays), etc.), non-scalability, fixed video wall content (e.g., one big message filling the video wall, different messages in display strings, different messages in “sub-video walls,” every display showing different images, etc.), and in general a standalone video matrix solution that may not leverage content distribution networking, streaming intelligence, etc., particular embodiments can include deploying video matrix functionality via an Internet protocol (IP) network.

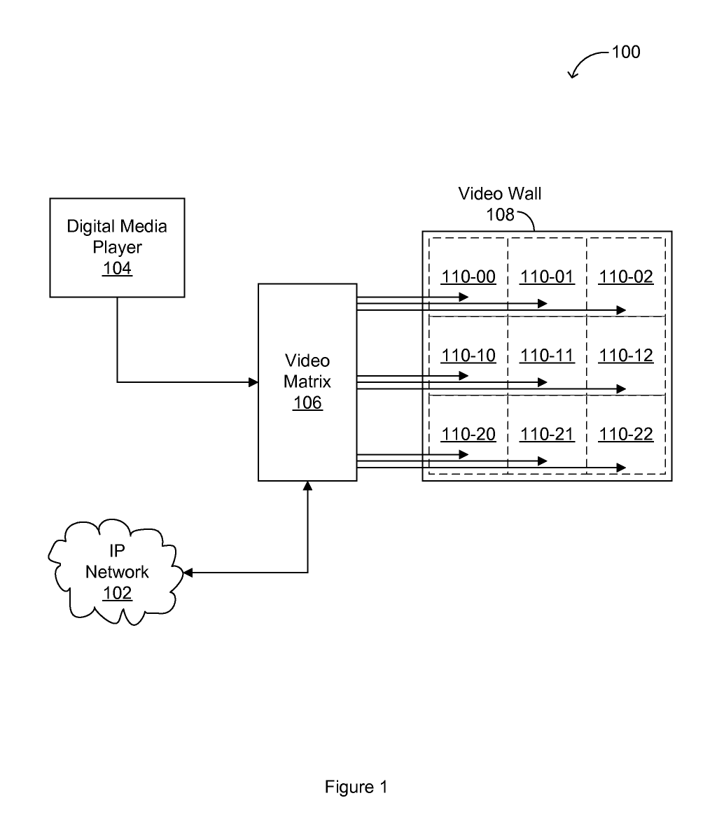

Referring now to FIG. 1, shown is an example 100 video wall system with localized video matrix control. A display can be video wall 108 that includes a plurality of display portions in a matrix (e.g., a first row of 110-00, 110-01, and 110-02, a second row of 110-10, 110-11, and 110-12, and a third row of 110-20, 110-21, and 110-22). For example, video wall 108 can be a billboard, a stadium video board, a home-based video wall, or any other suitably large display. Video matrix 106 can receive control signals from digital media player 104, as well as IP network 102. Video matrix 106 can essentially divide an incoming media content signal into various displayed portions, as shown.

However, a display portion size is generally fixed (e.g., 4×4, 10×4, 10×16, etc.) in this approach. Thus, in order to control different display portions, or build a video wall of a shape other than, e.g., a square or rectangular shape, video matrix 106 may be changed. This might be the case even to make a relatively minor change, such as in adding or removing a line to a video display (e.g., display portion 110-11), because video matrix 106 is generally comprised of hardware. In addition, digital media player 104 can be a set-top box (STB), cable modem (CM), video player, or any other suitable type of content playing or converting device. In some cases, digital media player 104 can be embedded within video matrix 106 and/or video wall 108.

In particular embodiments, an IP video wall, or a set of IP video walls, having size and shape flexibility can be provided. For example, each video wall or set of IP video walls can be enlarged or reshaped arbitrarily without changing and re-engineering the control system (e.g., the video matrix), but rather by adding distributed IP digital media receivers (e.g., IP displays, IP-STBs, etc.) coupled to an IP network.

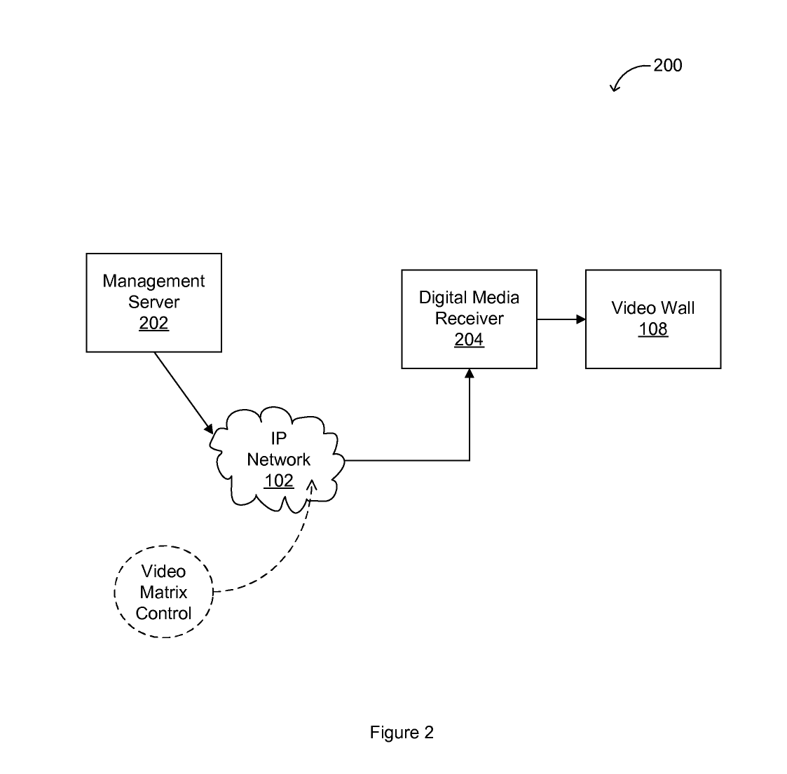

Referring now to FIG. 2, shown is an example 200 video wall system with video matrix control in an IP network. In this example, IP network 102 can have video matrix control functionality embedded therein or accessible thereby, which can then be provided to digital media receiver 204. Further, management server 202 can provide control signals, such as synchronization and timing controls, via IP network 102 to digital media receiver 204. Video wall 108 can then receive flexible video matrix-like controls from digital media receiver 204 for display.

In this approach, a one to one digital media receiver to display portion correspondence can be realized for increased flexibility. Video matrix functionality can essentially be moved from between a content player and the video wall to a logical aspect in IP network 102, which can then control many players coupled to portions or to different video walls. For example, a 4×4 video wall 108 display can include 16 digital media receivers 204, and a 4×5 video wall 108 display can simply add a 17^{th} digital media receiver 204. By controlling each display portion with each digital media receiver or player, different configurations can be supported, and based on video matrix control via IP network 102.

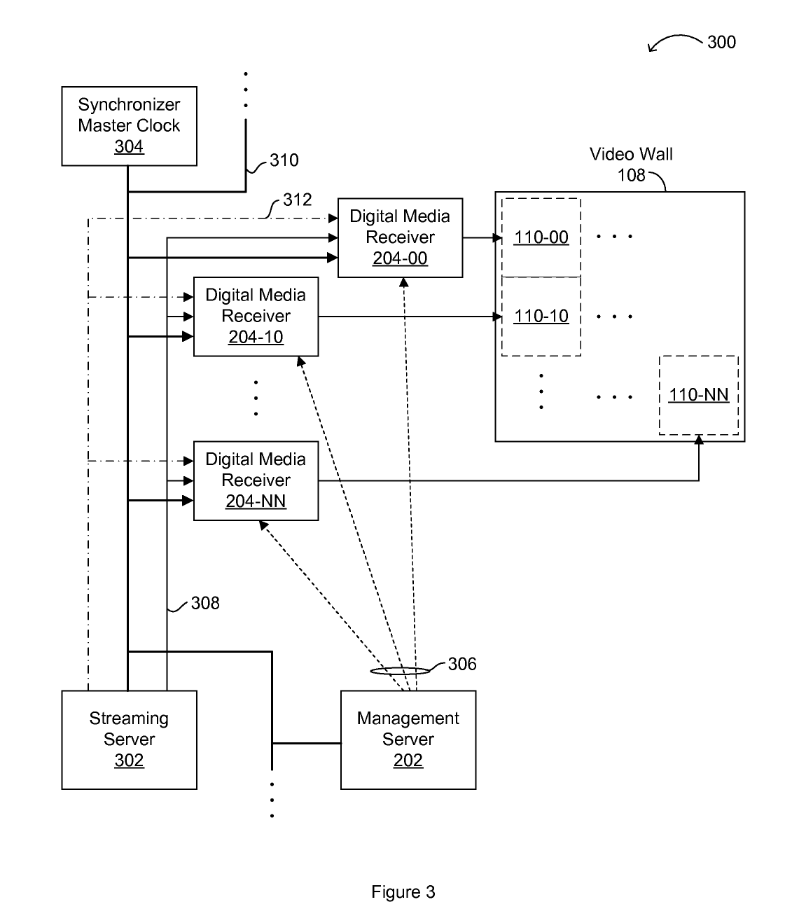

Referring now to FIG. 3, shown is an example 300 video wall control system. Video wall 108 can be divided into any suitable number of display portions (e.g., 110-00, 110-10, . . . 110-NN), and each display portion can have a corresponding digital media receiver (e.g., 204-00, 204-10, . . . 204-NN). As one particular example, streaming server 302 can provide control signals 308 (e.g., a multicast MP2TS (MPEG-2 transport stream)) and 312 (e.g., clock signaling) to digital media receivers 204. However, any broadcast or multicast stream over an IP network, such as a satellite stream encapsulated in IP or any other source, can be used as a source of a stream instead of streaming server 302. In this example, synchronizer master clock 304 can provide master clock signal 310 (e.g., IEEE 1588 Master) to digital media receivers 204, streaming server 302, and management server 202. Management server 202 can provide scaling configuration 306 to digital media receivers 204 for configuration of display portion 110.

Particular embodiments can include: (i) a matrix of, e.g., liquid crystal display (LCD) and/or plasma displays 110; (ii) a matrix of IP digital media receivers 204 (e.g., IP-STB), where each is connected to a corresponding display portion 110; (iii) a media server (e.g., streaming server 302) or other stream source, and a clock master (e.g., 304) to distribute and synchronize media content to digital media receivers 204; and (iv) a management server 202 for provisioning and management of the digital media receiver matrix (204/110) and the media/clock master. Management server 202 may be a master controller to control one or more video walls 108, by essentially determining what is to be displayed on each display portion 110 at a particular time.

In particular embodiments, digital media receiver video buffers may be synchronized (e.g., sub-ms) between digital media receivers 204 to display an image as a “single big image” or a seamless display. For example, IEEE 1588 can be used for synchronization at the sub-ms level to create a single big image on video wall 108. The IEEE 1588 specification can be realized in software plus relatively low cost chipset hardware while leveraging packet networking. Video walls in particular embodiments can be fed by different multimedia content (e.g., flash, 3d OpenGL (open graphics library) graphics, etc.) in addition to pure video streams, where appropriate rendering intelligence can be embedded into the receiving system. Such rendering intelligence may be part of digital media receiver 204, and can include a dedicated chipset plus suitable firmware as part of an overall digital media receiver operating system. Therefore, a broader synchronization method (e.g., IEEE 1588v2) can be used. However, any suitable synchronization approach can be employed in particular embodiments.

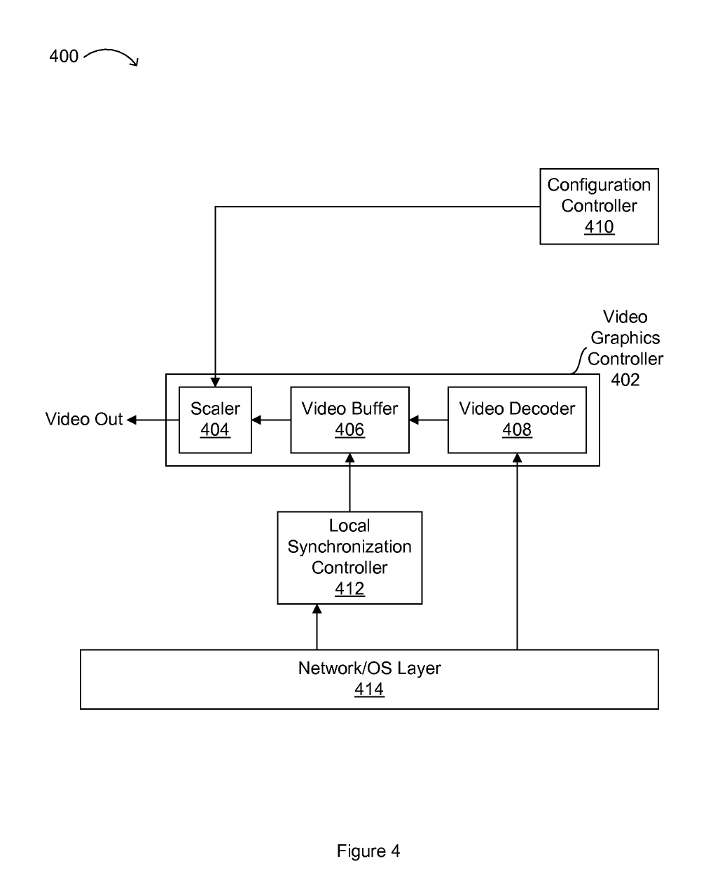

Referring now to FIG. 4, shown is an example 400 digital media receiver structure. In particular embodiments, each digital media receiver can display a “zone” or portion of incoming digital media. This can be done by each digital media receiver obtaining whole pictures and showing portions thereof, or by each digital media receiver obtaining a predetermined portion of the media content, as determined by, e.g., a configuration signal from management server 202. In either case, scaling hardware can be leveraged in a digital media receiver graphics adapter to convey, via provisioning, which zone is to be scaled by each specific digital media receiver. Thus, scaling can include both selecting a portion for display, then re-sizing such portion for display purposes. In one particular example, video graphics controller 402 can include scaler 404 controlled by configuration controller 410. An appropriate scaling can be used to embrace each kind of digital media (e.g., video, etc.), and scaler 404 may provide a video output for video content.

Video graphics controller 402 can also include video decoder 408 that receives a control signal (e.g., MP2TS with packet identification (PID)) from network/operating system (OS) layer 414, and provides a signal to video buffer 406. Local synchronization controller 412 can be an IEEE 1588 slave controller that can receive IEEE 1588 master clock packets from network/OS layer 414, and provide a buffer synchronization signal to video buffer 406. Moreover, architectures in particular embodiments can include hardware and software features, such as: (i) a SYNCoPacket (synchronization over packet standard and technologies, such as IEEE 1588) subsystem for video buffer sub-ms synchronization; and (ii) a configurable scaling circuit (e.g., 404) in video graphics controller 402.

Once the management server 202 has provisioned each digital media receiver 204 on a corresponding zone or display portion of responsibility, the hardware and software intelligence can display an appropriate zone of the digital media with sub-ms video buffer synchronization by the clocking source. The media server (e.g., streaming server 302), or another suitable stream source, can stream out video or other digital media content. Particular embodiments can also scale for many locations with a single management server or station covering the locations, and with many video walls in each location. Also, a clock master can be included in each such location.

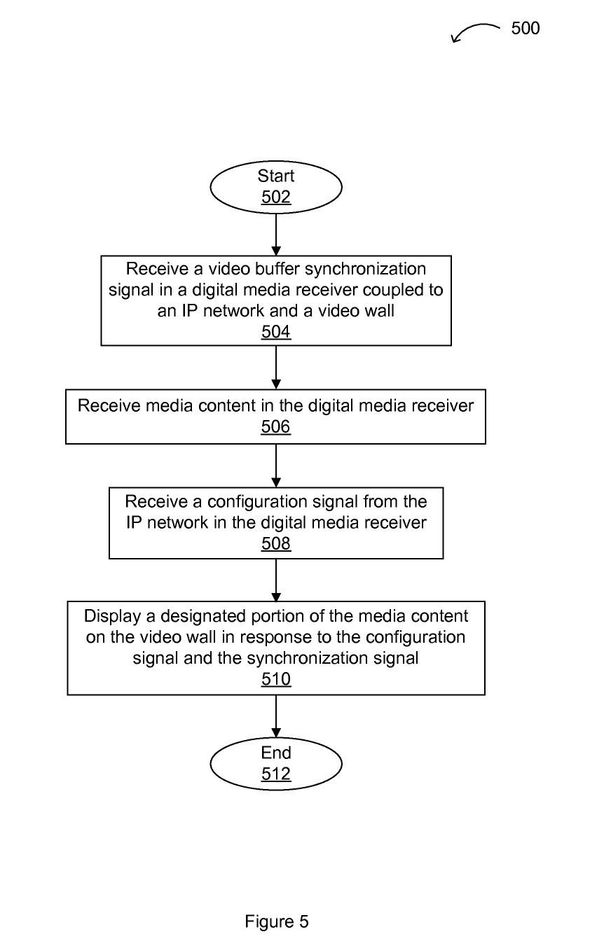

Referring now to FIG. 5, shown is a flow diagram 500 of an example method of controlling a video wall. The flow begins 502, and a video buffer synchronization signal (e.g., from master clock supplier 304) can be received in a digital media receiver that is coupled to an IP network and a video wall (504). Simultaneously or sequentially, digital media (e.g., from streaming server 302, or another stream source) can be received in the digital media receiver (506). Simultaneously or sequentially, a configuration signal (e.g., from management server 202) can also be received via the IP network (508). Such a configuration can include video matrix-like control. A designated portion of the digital media can then be displayed on the video wall in response to the configuration signal end the synchronization signal (510), completing the flow 512.

Accordingly, particular embodiments can include an IP network to which different IP digital media receivers are connected, sub-ms synchronization of associated video buffers leveraging packet standard technologies (e.g., IEEE 1588v2, IEEE 802 AVB (audio video bridging), etc.) occurs, a feed of the same or related digital media content and the same master clock to the digital media receivers occurs, and a conveying to each digital media receiver of a scale configuration on a different (e.g., x, y, x′, y′) portion of the media stream for display to support a video wall.

Particular embodiments create an IP networked approach for building and controlling a video matrix, thus bringing: (i) flexibility in video wall size and shape (where each IP digital media receiver is substantially independent but also part of the overall system) without changing or re-engineering the video matrix; (ii) dynamic changing what and how the video wall displays (e.g., one big message filling the video wall, different messages in display strings, different messages in “sub-video walls,” etc.); and (iii) flexibility of a networked solution leveraging content distribution networking, manageability, scalability, availability, and cost.

Although the description has been described with respect to particular embodiments thereof, these particular embodiments are merely illustrative, and not restrictive. For example, any broadcast, multimedia stream, or digital media over an IP network, such as a satellite stream encapsulated in IP or any other digital media source, can be utilized in particular embodiments.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method, comprising:
receiving a synchronization signal in a digital media receiver coupled to a network and a video wall;
receiving media content in the digital media receiver;
receiving a configuration signal via the network in the digital media receiver; and
displaying a designated portion of the media content on the video wall in response to the configuration signal and the synchronization signal.

2. The method of claim 1, wherein the synchronization signal comprises an IEEE 1588 master.

3. The method of claim 1, wherein the media content comprises video packets.

4. The method of claim 1, wherein the digital media receiver comprises a set-top box (STB).

5. The method of claim 1, wherein the network comprises an IP network.

6. The method of claim 1, wherein the media content is provided over the network.

7. The method of claim 1, wherein the configuration signal comprises a scaling control.

8. The method of claim 7, wherein the scaling control determines a size and a shape of the designated portion.

9. The method of claim 1, wherein the media content is received in a video buffer of the digital media receiver.

10. An apparatus, comprising:
one or more processors; and
logic encoded in one or more tangible media for execution by the one or more processors and when executed operable to:
receive a synchronization signal in a digital media receiver coupled to a network and a video wall;
receive media content in the digital media receiver;
receive a configuration signal via the network in the digital media receiver; and
display a designated portion of the media content on the video wall in response to the configuration signal and the synchronization signal.

11. The apparatus of claim 10, wherein the synchronization signal comprises an IEEE 1588 master.

12. The apparatus of claim 10, wherein the media content comprises video packets.

13. The apparatus of claim 10, wherein the digital media receiver comprises a set-top box (STB).

14. The apparatus of claim 10, wherein the network comprises an IP network.

15. The apparatus of claim 10, wherein the media content is provided over the network.

16. The apparatus of claim 10, wherein the configuration signal comprises a scaling control.

17. The apparatus of claim 16, wherein the scaling control is configured to determine a size and a shape of the designated portion.

18. The apparatus of claim 10, wherein the media content is received in a video buffer of the digital media receiver.

19. A system for controlling a video wall, comprising:
means for receiving a synchronization signal in a digital media receiver coupled to a network and a video wall;
means for receiving media content in the digital media receiver;
means for receiving a configuration signal via the network in the digital media receiver; and
means for displaying a designated portion of the media content on the video wall in response to the configuration signal and the synchronization signal.

20. The system of claim 19, further comprising means for providing the digital media over the network.
